(19) United States
(12) Patent Application Publication
(10) Pub. No.: US 2020/0084325 A1
(43) Pub. Date: Mar. 12, 2020

(54) IMAGE FORMATION APPARATUS, COMPUTER READABLE RECORDING MEDIUM, AND IMAGE FORMATION SYSTEM

(71) Applicant: Konica Minolta, Inc., Tokyo (JP)

(72) Inventor: Toshihiko Otake, Osaka (JP)

(73) Assignee: Konica Minolta, Inc., Tokyo (JP)

(21) Appl. No.: 16/567,407

(22) Filed: Sep. 11, 2019

(30) Foreign Application Priority Data
Sep. 12, 2018 (JP) 2018-170466

(51) Int. Cl. H04N 1/00

(52) U.S. Cl. CPC H04N 1/00403; H04N 2201/0094; H04N 1/00498; H04N 1/00347

(57) ABSTRACT

An image formation apparatus includes: a network interface connectable to another image formation apparatus via a network; and a controller that controls the image formation apparatus. The controller: receives an instruction via voice; determines whether the received instruction is intended for the other image formation apparatus; upon determining that the received instruction is intended for the other image formation apparatus, converts the received instruction into an instruction associated with the other image formation apparatus; and transmits the converted instruction to the other image formation apparatus.

### CROSS-REFERENCE TO RELATED APPLICATIONS

The entire disclosure of Japanese Patent Application No. 2018-170466, filed on Sep. 12, 2018, is incorporated herein by reference.

### BACKGROUND

### Technical Field

The present invention relates to an image formation apparatus, a computer readable recording medium, and an image formation system.

### Description of the Related Art

In recent years, as voice recognition is improved in accuracy, more and more image formation apparatuses are equipped with a voice recognition function and can receive an instruction from a user via voice and execute a process based on that instruction.

Japanese Laid-Open Patent Publication No. 2011-049705 discloses that an image processing system that is capable of enabling an image processing apparatus to implement a function by an application installed on an information processing apparatus and allowing users to perform an operation by voice entry via an operation screen that is displayed on a display of the image processing apparatus according to the application.

### SUMMARY

When image formation apparatuses that execute a process based on an instruction received via voice are networked, one image formation apparatus can receive an instruction intended for another image formation apparatus via voice, and the other image formation apparatus can be caused to execute a process based on that instruction. Specifically, one image formation apparatus receives an instruction intended for the other image formation apparatus via voice, and transmits the received voice's data to the other image formation apparatus. The other image formation apparatus executes a process based on an instruction included in the received voice's data.

However, a keyword that is used for an instruction issued to execute a process is not common to all image formation apparatuses. For example, a keyword that is used for an instruction issued to execute a process may vary among different image formation apparatus manufacturers. In addition, a keyword that is used for an instruction issued to execute a process may vary among different specifications for image formation apparatuses (for example, different languages that the image formation apparatuses can recognize). In such a case, the user must issue an instruction using a keyword that the other image formation apparatus can recognize, which is cumbersome.

Moreover, even when the same keyword is used, exactly the same process is not necessarily executed. For example, even when the same keyword is used a different process may be executed depending on the image formation apparatus's specific settings. In such a case, the user must issue an instruction while considering the other image formation apparatus's specific settings, which is cumbersome.

One or more embodiments of the present invention allow a user to issue an instruction to an image formation apparatus while the user does not need to consider how differently the image formation apparatus operates in response to the instruction.

An image formation apparatus of one or more embodiments of the present invention comprises a network interface connectable to another image formation apparatus via a network, and a controller that controls the image formation apparatus. The controller receives an instruction via voice; determines whether the received instruction is intended for the other image formation apparatus; converts the received instruction to an instruction associated with the other image formation apparatus when the controller determines that the received instruction is intended for the other image formation apparatus; and transmits the converted instruction to the other image formation apparatus.

According to one or more embodiments, there is provided a non-transitory, computer readable recording medium storing a program for controlling an image formation apparatus connectable to another image formation apparatus via a network. The program causes a computer to: receive an instruction via voice; determine whether the received instruction is intended for the other image formation apparatus; convert the received instruction to an instruction associated with the other image formation apparatus when the computer determines that the received instruction is intended for the other image formation apparatus; and transmit the converted instruction to the other image formation apparatus.

According to one or more embodiments, there is provided an image formation system comprising: a first image formation apparatus; and a second image formation apparatus connected to the first image formation apparatus via a network. The first image formation apparatus includes a controller that controls the first image formation apparatus. The controller of the first image formation apparatus receives an instruction via voice, determines whether the received instruction is intended for the second image formation apparatus, converts the received instruction to an instruction associated with the second image formation apparatus when the controller determines that the received instruction is intended for the second image formation apparatus, and transmits the converted instruction to the second image formation apparatus. The second image formation apparatus includes a controller that controls the second image formation apparatus. The controller of the second image formation apparatus receives the instruction transmitted by the first image formation apparatus, and executes a process based on the received instruction.

According to one or more embodiments, there is provided an image formation system comprising: a first image formation apparatus; and a second image formation apparatus connected to the first image formation apparatus via a network. The first image formation apparatus includes a controller that controls the first image formation apparatus. The controller of the first image formation apparatus receives an instruction via voice, determines whether the received instruction is intended for the second image formation apparatus, and transmits the received instruction to the second image formation apparatus when the controller determines that the received instruction is intended for the second image formation apparatus. The second image formation apparatus includes a controller that controls the second image formation apparatus. The controller of the second image formation apparatus receives the instruction transmitted by the first image formation apparatus, converts the received instruction to an instruction associated with the second image formation apparatus, and executes a process based on the converted instruction.

According to one or more embodiments, there is provided an image formation system comprising a first image formation apparatus; a second image formation apparatus; and a server connected to the first image formation apparatus and the second image formation apparatus via a network. The first image formation apparatus includes a controller that controls the first image formation apparatus. The controller of the first image formation apparatus receives an instruction via voice, determines whether the received instruction is intended for the second image formation apparatus, and transmits the received instruction to the server when the controller determines that the received instruction is intended for the second image formation apparatus. The server includes a controller that controls the server. The controller of the server converts the instruction transmitted by the first image formation apparatus to an instruction associated with the second image formation apparatus and transmits the converted instruction to the second image formation apparatus. The second image formation apparatus includes a controller that controls the second image formation apparatus. The controller of the second image formation apparatus receives the instruction transmitted by the server, and executes a process based on the received instruction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram for illustrating a network configuration according to one or more embodiments.

FIG. 2 is a block diagram showing a hardware configuration of an image formation apparatus according to one or more embodiments.

FIG. 3 is a flowchart of a process executed by a controller of the image formation apparatus according to one or more embodiments.

FIG. 4 shows a table TB1 collecting setting information of an image formation apparatus and another image formation apparatus connected thereto via a network according to one or more embodiments.

FIG. 5 shows a table TB2 collecting keywords for different manufacturers according to one or more embodiments.

FIG. 6 is a flowchart of a process executed by the controller to issue an instruction to an image formation apparatus to be instructed according to one or more embodiments.

FIG. 7 is a flowchart of a process executed by the controller to issue an instruction to an image formation apparatus to be instructed according to one or more embodiments.

FIG. 8 is a schematic diagram for illustrating a network configuration according to one or more embodiments.

FIG. 9 shows a table TB3 collecting keywords in different languages according to one or more embodiments.

FIG. 10 is a schematic diagram for illustrating a network configuration according to one or more embodiments.

FIG. 11 is a schematic diagram for illustrating a network configuration according to one or more embodiments.

### DETAILED DESCRIPTION

Hereinafter, embodiments of the present invention will be described with reference to the drawings. However, the scope of the invention is not limited to the disclosed embodiments.

Hereinafter, embodiments will more specifically be described with reference to the drawings. Note that identical or equivalent components are identically denoted and will not be described redundantly.

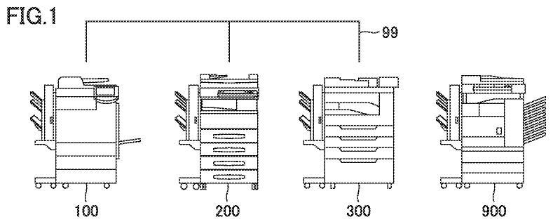

FIG. 1 is a schematic diagram for illustrating a network configuration according to one or more embodiments. An image formation apparatus 100 is connected to an image formation apparatus 200 and an image formation apparatus 300 by a network 99. Image formation apparatuses 100, 200, and 300 are installed at different sites. Network 99 enables image formation apparatuses 100, 200, and 300 installed at the different sites to communicate with one another. Image formation apparatuses 100, 200, and 300 may be installed in the same premises. Image formation apparatuses 100, 200, 300 are manufactured by different manufacturers. Image formation apparatus 100 is manufactured by a company X. Image formation apparatus 200 is manufactured by a company Y. Image formation apparatus 300 is manufactured by a company Z. Image formation apparatuses 100, 200, 300 all have a voice recognition function mounted therein and can recognize Japanese. Image formation apparatuses 100, 200, 300 can receive an instruction in Japanese and can execute a process based on the instruction. Further, image formation apparatus 100 can receive an instruction intended for image formation apparatus 200 and 300 in Japanese. Image formation apparatus 100 is not connected to an image formation apparatus 900 via network 99 and cannot receive via voice an instruction intended for image formation apparatus 900.

For each of image formation apparatuses 100, 200, 300, a sheet size for output and a color selection mode for output are set by default. The color selection mode is a mode for selecting a monochrome mode or a color mode. For image formation apparatus 100, a size of A4 is set by default as a sheet size for output, and the color mode is set by default as a color selection mode for output. For image formation apparatuses 200 and 300, a size of A4 is set by default as a sheet size for output, and the monochrome mode is set by default as a color selection mode for output.

When the user instructs image formation apparatus 100 to “print data A from image formation apparatus 200 in 2 in 1,” image formation apparatus 200 outputs data A printed on two pages per A4 sheet in color. When the user instructs image formation apparatus 100 to “print data A from image formation apparatus 300 in 2 in 1,” image formation apparatus 300 outputs data A printed on two pages per A4 sheet in color.

Thus, image formation apparatus 100 according to one or more embodiments can receive via voice an instruction intended for an image formation apparatus connected thereto via a network and capable of recognizing the same language as image formation apparatus 100 does, regardless of the manufacturer of the image formation apparatus to be instructed.

A hardware configuration of image formation apparatus 100 according to one or more embodiments will be described. Image formation apparatus 100 may be implemented in any form such as a multifunctional peripheral (MFP), a copier, a production machine (a commercial printer accommodating quick delivery, high-mix, small-lot production), a facsimile, a printer, etc.

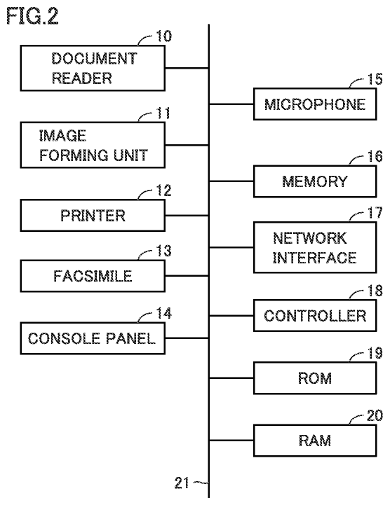

FIG. 2 is a block diagram showing a hardware configuration of image formation apparatus 100. Referring to FIG. 2, image formation apparatus 100 is a multi-functional peripheral, and comprises a document reader 10, an image forming unit 11, a printer 12, a facsimile 13, a console panel 14, a microphone 15, a memory 16, a network interface 17, a controller 18, a ROM (a Read Only Memory) 19, and a RAM (a Random Access Memory) 20, interconnected via a bus 21.

Document reader 10 optically reads an image of an original document fed from an automatic document feeder, an image of an original document placed on the platen glass or the like and transmits the read image to image forming unit 11 or the like.

Image forming unit 11 uses toner to form an image read by document reader 10, an image received from another apparatus, and the like. For monochrome printing, a toner of black is used to form an image, whereas for color printing, four color toners of yellow, magenta, cyan, and black are used to form an image.

Printer 12 prints on a sheet an image formed by image forming unit 11. Facsimile 13 transmits and receives image data to and from another facsimile machine via a telephone line. Console panel 14 is a touch panel display that displays a variety of types of information such as an operation screen and enables a user to perform a touch operation. Microphone 15 receives an instruction for an operation and the like from the user via voice. Memory 16 stores a variety of types of information. For example, it stores data of an image read by document reader 10, data of an image received from another apparatus, and data of voice received by microphone 15.

Network interface 17 is an interface for connecting image formation apparatus 100 to a network, and is a wired LAN, a wireless LAN, or the like. Network interface 17 is connected to another apparatus, and can receive data from the other apparatus for printing, transmit to the other apparatus the data of an image of an original document read by document reader 10, and/or transmit to the other image formation apparatus the data of the voice received by microphone 15.

Controller 18 comprises a CPU (Central Processing Unit) or the like. Controller 18 generally controls the operation of each component of image formation apparatus 100. ROM 19 stores a control program for controlling an operation of image formation apparatus 100. RAM 20 is a working memory for controller 18.

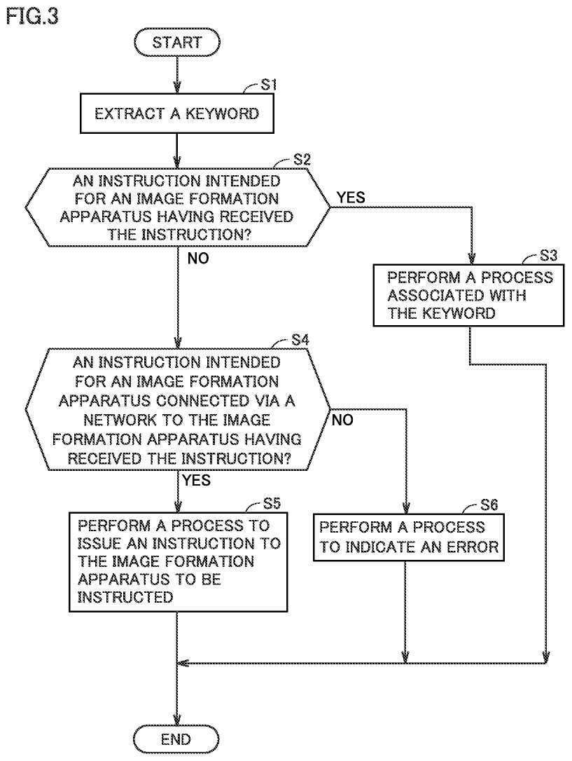

A process executed by controller 18 of image formation apparatus 100 when an instruction is received via voice will be described with reference to FIG. 3. FIG. 3 is a flowchart of a process executed by controller 18 of image formation apparatus 100.

Initially, when any instruction of a user is received via voice, controller 18 extracts a keyword relevant to the instruction from data of the received voice (step S1). A keyword relevant to an instruction includes, for example, a keyword that can identify an image formation apparatus to be instructed, a keyword that can specify a specific process, and the like. When the received instruction is “print data A in 2 in 1 from image formation apparatus 100,” controller 18 extracts “image formation apparatus 100,” “data A,” “2 in 1,” and “print.”

Subsequently, controller 18 determines whether the instruction is intended for image formation apparatus 100 that has received the instruction (step S2). For example, when the keywords extracted in step S1 include “image formation apparatus 100,” controller 18 determines that the instruction is intended for image formation apparatus 100. Note that when the keywords extracted in step S1 do not include a keyword that can identify an image formation apparatus to be instructed, controller 18 may consider that the keyword “image formation apparatus 100” is omitted and may determine that the instruction is intended for image formation apparatus 100.

When the instruction is intended for image formation apparatus 100 that has received the instruction (YES in step S2), controller 18 executes a process associated with the keyword included in the instruction (step S3). For example, when the received instruction is “print data A from image formation apparatus 100 in 2 in 1,” controller 18 outputs data A printed on two pages per A4 sheet in color. The data is output on an A4 sheet in color because for image formation apparatus 100 a size of A4 is set as a sheet size for output and a color mode is set as a color selection mode for output.

Note that after step S3 is completed, controller 18 may cause console panel 14 to display that the process is completed. In addition, controller 18 may signal that the process is completed to the address of a mobile terminal, a PC or the like of a target user via network 99. Further, controller 18 may notify the user that the process is completed audibly via a speaker with which image formation apparatus 100 equips. In addition, controller 18 may combine displaying on console panel 14, signaling via network 99, and audible notification via the speaker, as desired, to notify the user that the process is completed.

On the other hand, when the instruction is not intended for image formation apparatus 100 that has received the instruction (NO in step S2), controller 18 determines whether the instruction is intended for an image formation apparatus connected to image formation apparatus 100 via network 99 (e.g., image formation apparatuses, 200, 300, etc.) (step S4). When the instruction is intended for the image formation apparatus connected to image formation apparatus 100 via network 99 (YES in step S4), controller 18 proceeds to step S5. On the other hand, when the instruction is intended for an image formation apparatus which is not connected to image formation apparatus 100 via network 99 (e.g., image formation apparatus 900 or the like) (NO in step S4), controller 18 proceeds to step S6.

For example, when the keywords extracted in step S1 include “image formation apparatus 200,” controller 18 determines that the instruction is intended for image formation apparatus 200 connected to image formation apparatus 100 via network 99. Further, when the keywords extracted in step S1 include “image formation apparatus 300,” controller 18 determines that the instruction is intended for image formation apparatus 300 connected to image formation apparatus 100 via network 99. Further, when the keywords extracted in step S1 include the name of an image formation apparatus which is not connected to image formation apparatus 100 via network 99 (e.g., image formation apparatus 900 or the like), controller 18 determines that the instruction is intended for the image formation apparatus that is not connected to image formation apparatus 100 via network 99.

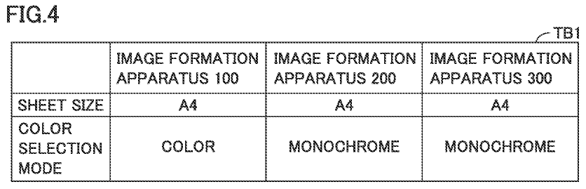

In step S5, controller 18 executes a process for issuing an instruction to an image formation apparatus to be instructed. This process will more specifically be described hereinafter with reference to FIGS. 4 to 7.

In step S6, controller 18 executes a process to indicate an error. For example, controller 18 causes console panel 14 to display that the instruction intended for image formation apparatus 900 cannot be received. Controller 18 may signal that the instruction cannot be received to the address of a mobile terminal, a PC or the like of a target user via network 99. Further, controller 18 may notify the user that the instruction cannot be received audibly via the speaker with which image formation apparatus 100 equips. In addition, controller 18 may combine displaying on console panel 14, signaling via network 99, and audible notification via the speaker, as desired, to notify the user that the instruction cannot be received.

After step S5, S6 or S3, controller 18 ends the process shown in FIG. 3.

With reference to FIGS. 4 to 7, when the instruction is intended for an image formation apparatus connected to image formation apparatus 100 via network 99 (e.g., image formation apparatus 200, 300, etc.), controller 18 executes a process to issue an instruction to the image formation apparatus to be instructed (step S5), as will be described hereinafter.

FIG. 4 shows a table TB1 collecting setting information (a first setting, options) of image formation apparatus 100 and image formation apparatus 200 and 300 connected thereto via network 99. Table TB1 is stored in ROM 19. Table TB1 shows the image formation apparatuses having pieces (types) of setting information associated therewith for output. Table TB1 is referred to when controller 18 adds information which a received instruction lacks.

For example, image formation apparatus 100 has A4 associated therewith as a sheet size for output, and color associated therewith as a color selection mode for output. In contrast, image formation apparatuses 200 and 300 have A4 associated therewith as a sheet size for output, and monochrome associated therewith as a color selection mode for output. This indicates that image formation apparatus 100 has a size of A4 set therefor by default as a sheet size for output, and a color mode set therefor by default as a color selection mode for output, and that image formation apparatuses 200 and 300 have a size of A4 set therefor by default as a sheet size for output, and a monochrome mode set therefor by default as a color selection mode for output.

While table TB1 only associates setting information for output, it is not limited as such. Table TB1 can associate a variety of types of setting information such as settings for copying, settings for printing, settings for scanning, settings for facsimile, settings for console panel 14 and the like.

While other than associating setting information for image formation apparatus 100, table TB1 only associates setting information for image formation apparatuses 200 and 300, the table is not limited as such. Other than associating setting information for image formation apparatus 100, table TB1 can associate setting information for an image formation apparatus connected to image formation apparatus 100 via network 99. Therefore, when in addition to image formation apparatuses 200 and 300 there is an image formation apparatus connected to image formation apparatus 100 via network 99, table TB1 also associates setting information for that image formation apparatus.

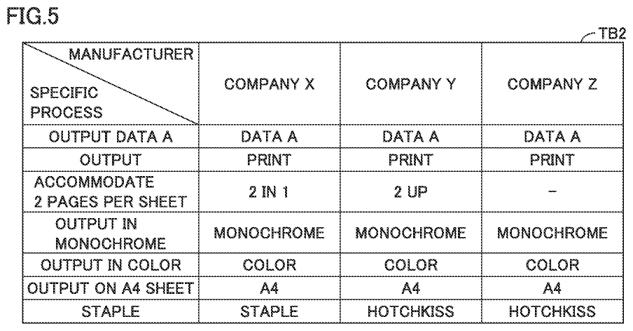

FIG. 5 shows a table TB2 collecting keywords (a second setting, options) for different manufacturers. Table TB2 is stored in ROM 19. Table TB2 associates a keyword that an image formation apparatus can recognize with a specific process (types) for each image formation apparatus manufacturer. Table TB2 is referred to when controller 18 converts a keyword included in an instruction to a keyword that an image formation apparatus to be instructed can recognize.

For example, for a manufacturer or company X, a keyword “2 in 1” is associated as a keyword indicating a process of “accommodating two pages per sheet.” For a manufacturer or company Y, a keyword “2 up” is associated as a keyword indicating the process of “accommodating two pages per sheet.” These indicate that manufacturers or companies X and Y use “2 in 1” and “2 up,” respectively, as a keyword indicating the process of “accommodating two pages per sheet.” In contrast, for a manufacturer or company Z, a keyword “-” is associated as a keyword indicating the process of “accommodating two pages per sheet.” This indicates that manufacturer or company Z's keyword indicating the process of “accommodating two pages per sheet” is currently unknown.

Note that while table TB2 mainly associates keywords for a printing process, it is not limited as such. In addition to the printing process, table TB2 can associate keywords relevant to a process executed by an image formation apparatus, such as a copying process, a scanning process, a facsimile process, a process relevant to setting console panel 14, a process relevant to setting the image formation apparatus, and the like.

Furthermore, data to be output in the printing process may be data stored in a storage of image formation apparatus 200 or 300 to be instructed, or may be data stored in a variety of devices (e.g., image formation apparatus 100, a PC, a server, etc.) connected via network 99 to image formation apparatus 200 or 300 to be instructed. When the data to be output is data stored in a variety of devices (e.g., image formation apparatus 100, a PC, a server, etc.) connected via network 99 to image formation apparatus 200 or 300 to be instructed, and image formation apparatus 200 or 300 receives an instruction from image formation apparatus 100, image formation apparatus 200 or 300 issues a request for the data via network 99 to the device that stores the data, receives the data, and outputs the data.

While table TB2 only associates keywords for manufacturers or companies X, Y and Z, the table can associate keywords for more manufacturers.

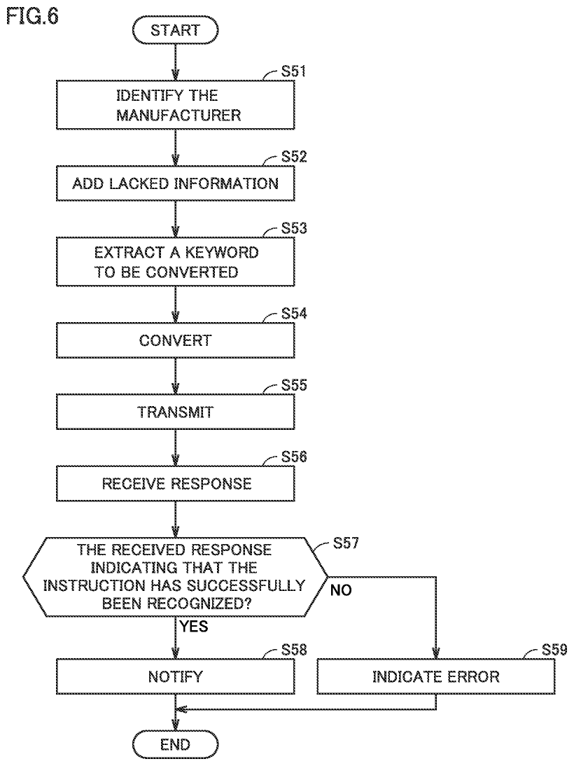

FIG. 6 is a flowchart of a process executed by controller 18 to issue an instruction to an image formation apparatus to be instructed (step S5). Hereinafter will be described a process executed by controller 18 when image formation apparatus 100 receives an instruction A to “print data A from image formation apparatus 200 in 2 in 1” and an instruction B to “print data A from image formation apparatus 300 in 2 in 1” by way of example.

Initially, controller 18 identifies the manufacturer of the image formation apparatus to be instructed (step S51). This is done in methods including: connecting to the image formation apparatus via network 99 to obtain information of the manufacturer from the image formation apparatus; previously registering in image formation apparatus 100 information of the manufacturer of the image formation apparatus connected to image formation apparatus 100 via network 99, and referring to the information; previously registering in a server connected to image formation apparatus 100 via network 99 information of the manufacturer of the image formation apparatus connected to image formation apparatus 100 via network 99, and referring to the information; and the like. In this scenario, controller 18 employs any of the above methods to identify that the manufacturer of image formation apparatus 200 is company Y and that of image formation apparatus 300 is company Z. Controller 18 executes a subsequent process based on the identified manufacturers.

Subsequently, controller 18 refers to table TB1 and adds information which the received instruction lacks (step S52). Specifically, initially, controller 18 refers to table TB1 to compare setting information of image formation apparatus 100 and setting information of the image formation apparatus to be instructed and determines any piece of the setting information of image formation apparatus 100 that is different from the setting information of the image formation apparatus to be instructed. In this scenario, controller 18 determines that information that a color selection mode for output is a color mode is setting information of image formation apparatus 100 that is different from the setting information of image formation apparatus 200 to be instructed. Furthermore, controller 18 determines that information that a color selection mode for output is a color mode is setting information of image formation apparatus 100 that is different from the setting information of image formation apparatus 300 to be instructed. Subsequently, controller 18 refers to table TB2 to add to the received instruction a keyword associated with a process corresponding to the different setting information that is associated with the manufacturer of the image formation apparatus to be instructed. In this scenario, the keywords for manufacturers Y and Z associated with a process of “outputting in color” are both “color,” and accordingly, controller 18 adds the keyword “color” to instructions A and B received.

Note that while controller 18 compares setting information of image formation apparatus 100 and setting information of an image formation apparatus to be instructed and adds to a received instruction only any piece of the setting information of image formation apparatus 100 that is different from the setting information of the image formation apparatus to be instructed, controller 18 may add all of the setting information of image formation apparatus 100 to the received instruction.

In general, when a user who usually often uses image formation apparatus 100 that is set to provide an output on an A4 sheet in color issues an instruction to “print,” it is believed that the user intends the instruction for outputting on an A4 sheet in color. However, if image formation apparatus 200 or 300 receives an instruction without a keyword “color,” image formation apparatus 200 or 300 follows its own specific settings and thus outputs data A in monochrome on an A4 sheet, and the user's intention included in his/her instruction to “print” is insufficiently reflected in the output. Accordingly, controller 18 adds information which the received instruction lacks (does not designate). Image formation apparatus 100 can thus accurately reflect the user's intention in an instruction intended for an image formation apparatus to be instructed.

Subsequently, controller 18 refers to table TB2 and extracts a keyword included in the received instruction that is to be converted (hereinafter also referred to as “a keyword to be converted”) (step S53). While a keyword indicating a specific process may be identically used by image formation apparatus manufacturers, another keyword indicating another specific process may vary among the manufacturers. Accordingly, controller 18 determines and extracts as a keyword to be converted a keyword included in the instruction for which in table TB2 different keywords are associated for the manufacturer of image formation apparatus 100 and that of the image formation apparatus to be instructed. Furthermore, controller 18 also determines and extracts as a keyword to be converted a keyword included in the instruction for which in table TB2 a keyword indicating the same specific process is not associated with the manufacturer of the image formation apparatus to be instructed. In contrast, controller 18 does not determine or extract as a keyword to be converted a keyword included in the instruction for which in table TB2 the same keyword is associated between the manufacturer of image formation apparatus 100 and that of the image formation apparatus to be instructed.

In this scenario, of the keywords included in instruction A, controller 18 determines and extracts a keyword “2 in 1” as a keyword to be converted. In contrast, of the keywords included in instruction A, controller 18 determines a keyword “data A” and a keyword “print” as keywords not to be converted, and does not extract them. Furthermore, of the keywords included in instruction B, controller 18 determines and extracts a keyword “2 in 1” as a keyword to be converted. In contrast, of the keywords included in instruction B, controller 18 determines a keyword “data A” and a keyword “print” as keywords not to be converted, and does not extract them.

Subsequently, controller 18 refers to table TB2 and accordingly converts the keyword extracted in step S53 to be converted (step S54). Specifically, controller 18 converts a keyword to be converted that is associated in table TB2 to a keyword associated with the manufacturer of the image formation apparatus to be instructed. Furthermore, controller 18 converts a keyword to be converted that is not associated in table TB2 to any keywords associated in table TB2 with the same specific process that the keyword to be converted is associated with.

In this scenario, controller 18 converts a keyword “2 in 1” included in instruction A and to be converted to a keyword “2 up.” Furthermore, controller 18 converts a keyword “2 in 1” included in instruction B and to be converted to a keyword “2 in 1” and a keyword “2 up.”

Then, controller 18 transmits a keyword added in step S52, if any, a keyword determined in step S53 as a keyword not to be converted, if any, and a keyword converted in step S54, if any, in the form of voice data to the image formation apparatus to be instructed (step S55).

In this scenario, controller 18 transmits a keyword “color” added in step S52, keywords “data A” and “print” determined in step S53 as keywords not to be converted, and a keyword “2 up” converted in step S54, in the form of voice data to image formation apparatus 200 to be instructed. Furthermore, controller 18 transmits a keyword “color” added in step S52, keywords “data A” and “print” determined in step S53 as keywords not to be converted, and keywords “2 in 1” and “2 up” converted in step S54, in the form of voice data to image formation apparatus 300 to be instructed.

Thus image formation apparatus 100 can transmit an instruction that accurately reflects the user's intention to an image formation apparatus to be instructed. In addition, when image formation apparatus 100 has a keyword recognizable by an image formation apparatus to be instructed, the former can transmit to the latter an instruction composed of the keyword recognizable by the latter. Furthermore, when image formation apparatus 100 does not have a keyword recognizable by an image formation apparatus to be instructed, the former can transmit to the latter any keywords associated with the same specific process that a keyword to be converted is associated with.

Subsequently, controller 18 receives from a destination image formation apparatus a response indicating whether the instruction has successfully been recognized (step S56). In this scenario, controller 18 receives from destination image formation apparatuses 200 and 300 a response indicating whether an instruction has successfully been recognized.

Subsequently, controller 18 determines whether the received response indicates that the instruction has successfully been recognized (step S57). When the received response indicates that the instruction has successfully been recognized (YES in step S57), controller 18 notifies the user accordingly (step S58) and ends the FIG. 6 process. When the received response indicates that the instruction has not successfully been recognized (NO in step S57), controller 18 notifies the user accordingly (or of an error) (step S59) and ends the FIG. 6 process.

When it is assumed that image formation apparatus 100 receives a response from both image formation apparatuses 200 and 300 indicating that the instruction has successfully been recognized, controller 18 causes console panel 14 to display that image formation apparatus 200 to be instructed has successfully recognized an instruction and that image formation apparatus 300 to be instructed has successfully recognized an instruction.

Thus, with reference to FIG. 6, a process has been described in which when image formation apparatus 100 receives an instruction intended for image formation apparatuses 200 and 300 connected to image formation apparatus 100 via network 99 controller 18 issues an instruction to an image formation apparatus to be instructed. In the FIG. 6 process, controller 18 converts a keyword to be converted that is not associated in table TB2 to any keywords associated in table TB2 with the same specific process that the keyword to be converted is associated with, and controller 18 transmits the converted keywords all at once to an image formation apparatus to be instructed.

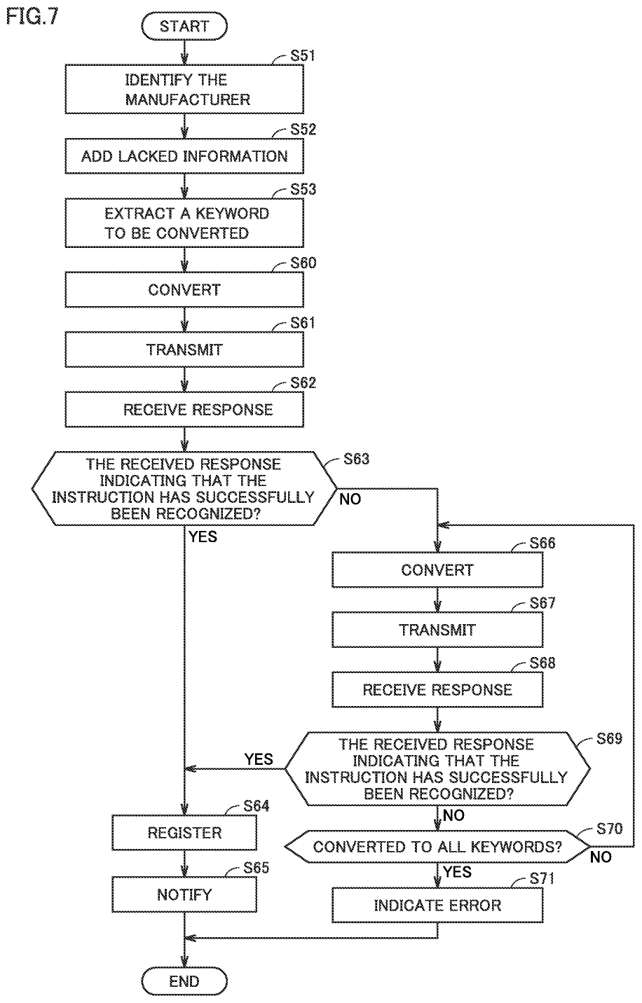

However, as shown in FIG. 7, controller 18 may not convert a keyword to be converted that is not associated in table TB2 and may instead transmit the keyword as it is, and when the image formation apparatus to be instructed does not recognize the instruction, controller 18 may sequentially convert the keyword to any keywords associated with the same specific process that the keyword to be converted is associated with, and transmit the converted keyword. FIG. 7 is a flowchart of a process executed by controller 18 to issue an instruction to an image formation apparatus to be instructed (step S5). Hereinafter will be described a process executed by controller 18 when image formation apparatus 100 receives an instruction A to “print data A from image formation apparatus 200 in 2 in 1” and an instruction B to “print data A from image formation apparatus 300 in 2 in 1” by way of example. Note that any step in FIG. 7 identical or equivalent to that in FIG. 6 will not be described redundantly.

Initially, controller 18 executes steps S51 to S53 and proceeds to step S60. In step S60, controller 18 converts a keyword to be converted that is associated in table TB2 to a keyword associated with the manufacturer of the image formation apparatus to be instructed. Controller 18 does not convert a keyword to be converted that is not associated in table TB2 to any keyword.

In this scenario, controller 18 converts a keyword “2 in 1” included in instruction A and to be converted to a keyword “2 up.” Furthermore, controller 18 does not convert a keyword “2 in 1” included in instruction B and to be converted.

Then, controller 18 transmits a keyword added in step S52, if any, a keyword determined in step S53 as a keyword not to be converted, if any, a keyword converted in step S60, if any, and a keyword that has not been converted in step S60, if any, in the form of voice data to the image formation apparatus to be instructed (step S61).

In this scenario, controller 18 transmits a keyword “color” added in step S52, keywords “data A” and “print” determined in step S53 as keywords not to be converted, and a keyword “2 up” converted in step S60, in the form of voice data to image formation apparatus 200 to be instructed. Furthermore, controller 18 transmits a keyword “color” added in step S52, keywords “data A” and “print” determined in step S53 as keywords not to be converted, and a keyword “2 in 1” that has not been converted in the S60 conversion step, in the form of voice data to image formation apparatus 300 to be instructed.

Subsequently, controller 18 receives from a destination image formation apparatus a response indicating whether the instruction has successfully been recognized (step S62). In this scenario, controller 18 receives from destination image formation apparatuses 200 and 300 a response indicating whether an instruction has successfully been recognized.

Subsequently, controller 18 determines whether the received response indicates that the instruction has successfully been recognized (step S63). When the received response indicates that the instruction has successfully been recognized (YES in step S63), controller 18 proceeds to step S64. When the received response indicates that the instruction has not successfully been recognized (NO in step S63), controller 18 proceeds to step S66.

In this scenario, it is assumed that image formation apparatus 100 receives a response from image formation apparatus 200 indicating that it has successfully recognized the instruction and a response from image formation apparatus 300 indicating that it has not successfully recognized the instruction.

In step S64, controller 18 associates an immediately previously transmitted keyword that is not associated in table TB2 with the manufacturer of an image formation apparatus to be instructed with the manufacturer of the image formation apparatus to be instructed and a specific process, and thus registers them. In this scenario, the keywords transmitted to image formation apparatus 200 (i.e., the keyword “color,” the keyword “data A,” the keyword “print,” and the keyword “2 up”) are all associated in table TB2 with the manufacturer of the image formation apparatus to be instructed, and accordingly, controller 18 does not register them and proceeds to step S65.

In step S65, controller 18 causes console panel 14 to display that the image formation apparatus to be instructed has successfully recognized the instruction, and ends the FIG. 7 process. In this scenario, controller 18 causes console panel 14 to display that image formation apparatus 200 to be instructed has successfully recognized the instruction, and ends the process.

In step S66, controller 18 converts a keyword which was not converted in the S60 conversion step to one keyword associated in table TB2 with the same specific process. When there is a plurality of keywords associated with the same specific process that the keyword that was not converted in the S60 conversion step is associated with, controller 18 in step S66 executed for the first time converts the keyword to a keyword highest in conversion frequency and in step S66 executed for the second time converts the keyword to a keyword secondly highest in conversion frequency etc. or similarly converts the keyword in accordance with some criterion sequentially. In this scenario, controller 18 converts a keyword “2 in 1” included in instruction B to a keyword “2 up.”

Subsequently, controller 18 may transmit a keyword converted in step S66, in the form of voice data to an image formation apparatus to be instructed (step S67). In this scenario, controller 18 transmits a keyword “2 up” in the form of voice data to image formation apparatus 300 to be instructed.

Subsequently, controller 18 receives from a destination image formation apparatus a response indicating whether an instruction has successfully been recognized (step S68). In this scenario, controller 18 receives from destination image formation apparatus 300 a response indicating whether an instruction has successfully been recognized.

Subsequently, controller 18 determines whether the received response indicates that the instruction has successfully been recognized (step S69). When the received response indicates that the instruction has successfully been recognized (YES in step S69), controller 18 proceeds to step S64.

When it is assumed that image formation apparatus 100 receives from destination image formation apparatus 300 a response indicating that the instruction has successfully been recognized, the immediately previously transmitted keyword “2 up” is not associated in table TB2 with the manufacturer of image formation apparatus 300, or company Z, and accordingly, in step S64, controller 18 associates the keyword “2 up” with the manufacturer of image formation apparatus 300, or company Z, and a specific process of “accommodating two pages per sheet” and thus registers them.

When the received response indicates that the instruction has not successfully been recognized (NO in step S69), controller 18 proceeds to step S70.

In step S70, controller 18 determines whether the keyword that was not converted in the S60 conversion step has been converted to any keywords associated in table TB2 with the same specific process that the keyword that was not converted in step S60 is associated with.

When the keyword that was not converted in the S60 conversion step has been converted to any keywords associated in table TB2 with the same specific process that the keyword that was not converted in step S60 is associated with (YES in step S70), controller 18 notifies the user that the image formation apparatus to be instructed has failed to successfully recognize the instruction (or of an error) (step S71), and ends the FIG. 7 process. In contrast, when the keyword that was not converted in the S60 conversion step has not yet been converted to all of the keywords associated in table TB2 with the same specific process that the keyword that was not converted in step S60 is associated with (NO in step S70), controller 18 returns to step S66 and converts the keyword.

Thus, with reference to FIGS. 6 and 7, a process has been described which controller 18 executes when an instruction intended for image formation apparatuses 200 and 300 connected to image formation apparatus 100 via network 99 is received via voice. When controller 18 executes the process shown in FIG. 6 or FIG. 7, the image formation apparatus to be instructed can receive a recognizable instruction from image formation apparatus 100. As a result, the image formation apparatus to be instructed can execute a process based on the instruction.

Note that how the user is notified in the FIG. 6 steps S58 and S59 and the FIG. 7 steps S65 and S71 is not limited to displaying on console panel 14. Controller 18 may signal via network 99 to the address of a mobile terminal, a PC or the like of a target user. Furthermore, controller 18 may notify the user audibly via a speaker which image formation apparatus 100 equips with. Furthermore, controller 18 may combine displaying on console panel 14, signaling via network 99, and audible notification via the speaker, as desired, to notify the user.

Furthermore, what the user is notified of in the FIG. 6 steps S58 and S59 and in the FIG. 7 steps S65 and S71 is not limited to whether an image formation apparatus to be instructed has successfully received an instruction. For example, controller 18 may notify the user of whether an image formation apparatus to be instructed has completed a process based on an instruction.

Thus, image formation apparatus 100 according to one or more embodiments can receive an instruction intended for an image formation apparatus connected via network 99 and capable of recognizing the same language that image formation apparatus 100 can recognize, via voice, regardless of the manufacturer of the image formation apparatus. The image formation apparatus according to one or more embodiments has effects, as enumerated below:

(1) When image formation apparatus 100 receives an instruction via voice, image formation apparatus 100 determines which image formation apparatus the instruction is intended for (steps S2 and S4), and image formation apparatus 100 performs steps matching the image formation apparatus to be instructed (steps S3, S5, and S6).

This allows a user to issue to image formation apparatus 100 not only an instruction intended for image formation apparatus 100 but also an instruction intended for an image formation apparatus connected to image formation apparatus 100 via network 99.

(2) When a received instruction is intended for the image formation apparatus connected to image formation apparatus 100 via network 99, image formation apparatus 100 adds information which the received instruction lacks to an instruction to be transmitted to the image formation apparatus to be instructed (step S52).

This allows a user to issue an instruction without having to worry about setting information of the image formation apparatus to be instructed.

(3) When the received instruction is intended for the image formation apparatus connected to image formation apparatus 100 via network 99, image formation apparatus 100 converts a keyword included in the received instruction that is not used by the manufacturer of the image formation apparatus to be instructed to a keyword used by the manufacturer of the image formation apparatus to be instructed (steps S54 and S60), and transmits the converted keyword in the form of voice data to the image formation apparatus to be instructed (steps S55, S61).

This allows a user to issue an instruction without having to worry about a keyword used by the manufacturer of the image formation apparatus to be instructed.

(4) When the received instruction is intended for the image formation apparatus connected to image formation apparatus 100 via network 99, image formation apparatus 100 notifies the user of whether the image formation apparatus to be instructed has successfully recognized the instruction (steps S58, S59, S65, and S71).

The user can thus understand whether the instruction has been received by the image formation apparatus to be instructed.

(5) When the received instruction is intended for the image formation apparatus connected to image formation apparatus 100 via network 99, and image formation apparatus 100 does not have a keyword used by the manufacturer of the image formation apparatus to be instructed, image formation apparatus 100 converts a keyword included in the received instruction to any keywords associated with the same specific process and thus transmits the converted keyword (steps S54 and S55).

This allows a user to issue an instruction without having to worry about a keyword used by the manufacturer of the image formation apparatus to be instructed.

(6) When the received instruction is intended for the image formation apparatus connected to image formation apparatus 100 via network 99, and image formation apparatus 100 does not have a keyword used by the manufacturer of the image formation apparatus to be instructed, image formation apparatus 100 sequentially converts a keyword included in the received instruction to keywords associated with the same specific process and used by a manufacturer different from the manufacturer of the image formation apparatus to be instructed, and thus transmits the converted keyword (steps S66 and S67). Furthermore, when image formation apparatus 100 receives from a destination image formation apparatus a response indicating that an instruction has successfully been recognized, image formation apparatus 100 associates the immediately previously transmitted keyword with the manufacturer of the image formation apparatus to be instructed and a specific process, and thus registers them (step S64).

This allows a user to issue an instruction without having to worry about a keyword used by the manufacturer of the image formation apparatus to be instructed. Further, keywords recognized by the image formation apparatus to be instructed can be accumulated, and hence referred to in subsequent conversion processes.

While in one or more embodiments only two image formation apparatuses 200 and 300 are connected to image formation apparatus 100 via network 99, more image formation apparatuses may be connected thereto. Further, while in one or more embodiments the language that image formation apparatus 100 and an image formation apparatus connected to image formation apparatus 100 via network 99 can recognize is Japanese, the image formation apparatus may be able to recognize a language other than Japanese.

Further, table TB1 and table TB2 may not be stored in image formation apparatus 100 and instead be stored in a device other than image formation apparatus 100. For example, it is conceivable to store table TB1 and table TB2 in a server connected to network 99. The server may be a server connected to image formation apparatus 100 via an in-house LAN, or may be a server connected via the Internet. Image formation apparatus 100 refers via network 99 to table TB1 and table TB2 stored in the server.

Further, while in one or more embodiments table TB2 associates a keyword that can be recognized by an image formation apparatus with a specific process for each image formation apparatus manufacturer, the table may associate the keyword with the specific process for each image formation apparatus.

Further, image formation apparatus 100 may have a built-in telephone function so that a user of image formation apparatus 100 and a user of the image formation apparatus to be instructed can talk to each other via image formation apparatus 100. Further, image formation apparatus 100 may be configured to allow the user of image formation apparatus 100 during a call in a call mode to switch the call mode to a mode allowing the user to issue an instruction to an image formation apparatus to be instructed, as desired.

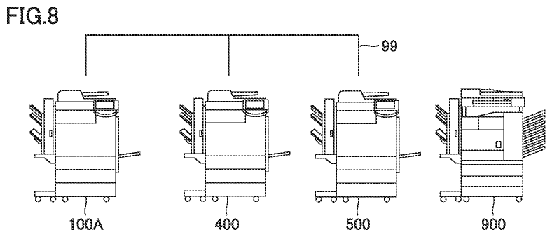

FIG. 8 is a schematic diagram for illustrating a network configuration according to one or more embodiments. In the aforementioned embodiments, while image formation apparatuses 200 and 300 connected to image formation apparatus 100 via network 99 can recognize the same language as image formation apparatus 100 can, image formation apparatuses 200 and 300 are manufactured by manufacturers different from the manufacturer of image formation apparatus 100. In one or more embodiments, while image formation apparatuses 400, 500 connected to an image formation apparatus 100A via network 99 are manufactured by the same manufacturer as image formation apparatus 100A, image formation apparatuses 400, 500 recognize languages different from that which image formation apparatus 100A recognizes.

Image formation apparatus 100A is connected to image formation apparatuses 400 and 500 via network 99. Image formation apparatuses 100A, and 400 and 500 are manufactured by the same manufacturer. Although image formation apparatuses 100A, and 400 and 500 all have a voice recognition function, they recognize different languages. Image formation apparatus 100A can recognize Japanese. Image formation apparatus 400 can recognize English. Image formation apparatus 500 can recognize German. Image formation apparatuses 100A, and 400 and 500 can each receive an instruction in a recognizable language and execute a process based on the instruction. Further, image formation apparatus 100A can receive via voice an instruction intended for image formation apparatuses 400 and 500. Image formation apparatus 100A is not connected to image formation apparatus 900 via network 99 and cannot receive via voice an instruction intended for image formation apparatus 900.

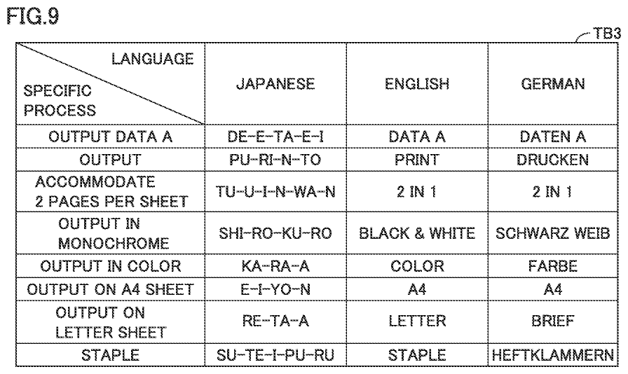

Image formation apparatus 100A according to one or more embodiments has the same hardware configuration as image formation apparatus 100 according to the aforementioned embodiments (see FIG. 2). Furthermore, image formation apparatus 100A according to one or more embodiments, as well as image formation apparatus 100 according to the aforementioned embodiments, performs steps S1 to S6. However, image formation apparatus 100A according to one or more embodiments refers in step S5 to a table different from that referred to in the aforementioned embodiments. Further, image formation apparatus 100A according to one or more embodiments identifies information different from that in the aforementioned embodiments for step S51. Hereafter, referring to FIG. 9, a point different than the aforementioned embodiments will be described.

FIG. 9 shows a table TB3 collecting keywords for different languages. In the aforementioned embodiments, when controller 18 converts a keyword included in an instruction to a keyword that an image formation apparatus to be instructed can recognize, controller 18 refers to table TB2 that collects keywords for each manufacturer. In the one or more embodiments, controller 18 refers to table TB3 that collects keywords for each language when controller 18 converts a keyword included in an instruction to a keyword that an image formation apparatus to be instructed can recognize.

Table TB3 is stored in ROM 19. Table TB3 associates a keyword that an image formation apparatus can recognize with a specific process for each language that an image formation apparatus can recognize. Table TB3 is referred to when controller 18 converts a keyword included in an instruction to a keyword that an image formation apparatus to be instructed can recognize.

Furthermore, in the aforementioned embodiments, when image formation apparatus 100 receives an instruction intended for image formation apparatuses 200 and 300 connected via network 99, controller 18 identifies the manufacturers of image formation apparatus 200, 300 to be instructed (step S51). In one or more embodiments, when image formation apparatus 100A receives an instruction intended for image formation apparatuses 400 and 500 connected via network 99, controller 18 identifies a language that image formation apparatuses 400 and 500 to be instructed can recognize. Based on the language identified, controller 18 refers to table TB3 collecting keywords for each language and accordingly converts a keyword to a keyword that image formation apparatuses 400 and 500 to be instructed can recognize.

Note that while table TB3 mainly associates keywords for a printing process, it is not limited as such. In addition to the printing process, table TB3 can associate keywords relevant to a process executed by an image formation apparatus, such as a copying process, a scanning process, a facsimile process, a process relevant to setting console panel 14, a process relevant to setting the image formation apparatus, and the like.

While table TB3 only associates keywords in Japanese, English and German, the table can associate keywords for more languages.

Note that when controller 18 adds information which the received instruction lacks, then, similarly as has been described in the aforementioned embodiments, controller 18 refers to a table TB4 (not shown) collecting setting information of image formation apparatus 100A and image formation apparatuses 400 and 500 connected thereto via network 99.

In one or more embodiments, when an instruction is intended for image formation apparatuses 400 and 500 connected to image formation apparatus 100A via network 99, controller 18 executes the FIGS. 6 and 7 processes with reference to tables TB3 and TB4. Of the steps executed, in step S51, controller 18 identifies a language that image formation apparatuses 400, 500 to be instructed can recognize, rather than their manufacturers. Further, based on the language identified, controller 18 executes the FIGS. 6 and 7 processes.

Thus, image formation apparatus 100 according to one or more embodiments can receive an instruction intended for an image formation apparatus connected thereto via network 99 and manufactured by the same manufacturer, via voice, regardless of which language the image formation apparatus to be instructed can recognize. The image formation apparatus according to one or more embodiments has effects, as enumerated below:

(1) When image formation apparatus 100A receives an instruction via voice, image formation apparatus 100A determines which image formation apparatus the instruction is intended for (steps S2 and S4), and image formation apparatus 100A performs steps matching the image formation apparatus to be instructed (steps S3, S5, and S6).

This allows a user to issue to image formation apparatus 100A not only an instruction intended for image formation apparatus 100A but also an instruction intended for an image formation apparatus connected to image formation apparatus 100A via network 99.

(2) When a received instruction is intended for the image formation apparatus connected to image formation apparatus 100A via network 99, image formation apparatus 100A adds information which the received instruction lacks to an instruction to be transmitted to the image formation apparatus to be instructed (step S52).

This allows a user to issue an instruction without having to worry about setting information of the image formation apparatus to be instructed.

(3) When the received instruction is intended for the image formation apparatus connected to image formation apparatus 100A via network 99, image formation apparatus 100A converts a keyword included in the received instruction that the image formation apparatus to be instructed cannot recognize to a keyword in a language that the image formation apparatus to be instructed can recognize (steps S54 and S60), and transmits the converted keyword in the form of voice data to the image formation apparatus to be instructed (steps S55, S61).

This allows a user to issue an instruction without having to worry about which language the image formation apparatus to be instructed can recognize.

(4) When a received instruction is intended for the image formation apparatus connected to image formation apparatus 100A via network 99, image formation apparatus 100A notifies the user of whether the image formation apparatus to be instructed has successfully recognized the instruction (steps S58, S59, S65, and S71).

The user can thus understand whether the instruction has been received by the image formation apparatus to be instructed.

(5) When the received instruction is intended for the image formation apparatus connected to image formation apparatus 100A via network 99, and image formation apparatus 100A does not have a keyword in a language that the image formation apparatus to be instructed can recognize, image formation apparatus 100A converts a keyword included in the received instruction to any keywords associated with the same specific process and thus transmits the converted keyword (steps S54 and S55).

This allows a user to issue an instruction without having to worry about which language the image formation apparatus to be instructed can recognize.

(6) When the received instruction is intended for the image formation apparatus connected to image formation apparatus 100A via network 99, and image formation apparatus 100A does not have a keyword in a language that the image formation apparatus to be instructed can recognize, image formation apparatus 100A converts a keyword included in the received instruction sequentially to any keywords associated with the same specific process and thus transmits the converted keyword (steps S66 and S67). Furthermore, when image formation apparatus 100A receives from a destination image formation apparatus a response indicating that an instruction has successfully been recognized, image formation apparatus 100A associates the immediately previously transmitted keyword with the language that the image formation apparatus to be instructed can recognize and a specific process, and thus registers them (step S64).

This allows a user to issue an instruction without having to worry about which language the image formation apparatus to be instructed can recognize. Further, keywords recognized by the image formation apparatus to be instructed can be accumulated, and hence referred to in subsequent conversion processes.

In one or more embodiments the number of image formation apparatuses connected to image formation apparatus 100A via network 99 is not limited to a single image formation apparatus and a plurality of image formation apparatuses may be connected.

Further, in one or more embodiments, table TB3 and table TB4 may not be stored in image formation apparatus 100A and instead be stored in a device other than image formation apparatus 100A. For example, it is conceivable to store table TB3 and table TB4 in a server connected to network 99. The server may be a server connected to image formation apparatus 100A via an in-house LAN, or may be a server connected via the Internet. Image formation apparatus 100A refers via network 99 to table TB3 and table TB4 stored in the server.

Further, while in one or more embodiments table TB3 associates a keyword that an image formation apparatus can recognize with a specific process for each language that an image formation apparatus can recognize, the table may associate the keyword with the specific process for each image formation apparatus.

Further, image formation apparatus 100A may have a built-in telephone function so that a user of image formation apparatus 100A and a user of the image formation apparatus to be instructed can talk to each other via image formation apparatus 100A. Further, image formation apparatus 100A may be configured to allow the user of image formation apparatus 100A during a call in a call mode to switch the call mode to a mode allowing the user to issue an instruction to an image formation apparatus to be instructed, as desired.

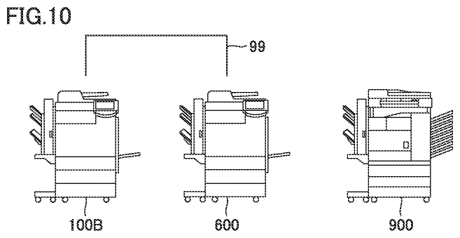

FIG. 10 is a schematic diagram for illustrating a network configuration according to one or more embodiments. An image formation apparatus 100B is connected to an image formation apparatus 600 via network 99. Image formation apparatuses 100B and 600 both have a voice recognition function mounted therein and can recognize voice. Image formation apparatuses 100B and 600 can receive an instruction via voice and can execute a process based on the instruction. Further, image formation apparatus 100B can receive via voice an instruction intended for image formation apparatus 600. Image formation apparatus 100B is not connected to image formation apparatus 900 via network 99 and cannot receive via voice an instruction intended for image formation apparatus 900.

In one or more embodiments, a part of step S5 performed in image formation apparatus 100 according to the aforementioned embodiments or image formation apparatus 100A according to the aforementioned embodiments is performed in image formation apparatus 600 to be instructed. Specifically, in the aforementioned embodiments, when image formation apparatus 100 or 100A receives via voice an instruction intended for an image formation apparatus connected via network 99 (e.g., image formation apparatuses 200, 300, 400, 500), image formation apparatus 100 or 100A converts the instruction and transmits the converted instruction to the image formation apparatus to be instructed.

In one or more embodiments, in contrast, when image formation apparatus 100B receives via voice an instruction intended for image formation apparatus 600 connected to image formation apparatus 100B via network 99, image formation apparatus 100B does not convert the received instruction and transmits the instruction to image formation apparatus 600 to be instructed in the form of voice data. When image formation apparatus 600 to be instructed receives the instruction transmitted from image formation apparatus 100B, image formation apparatus 600 to be instructed converts the instruction and executes a process corresponding to the converted instruction. Specifically, initially, when image formation apparatus 600 to be instructed receives an instruction transmitted from image formation apparatus 100B, image formation apparatus 600 to be instructed identifies information of image formation apparatus 100B (the manufacturer of image formation apparatus 100B, a language that image formation apparatus 100B can recognize, etc.), and adds lacked information to the instruction. Subsequently, image formation apparatus 600 to be instructed converts a keyword included in the instruction to a keyword that the image formation apparatus can recognize, and the image formation apparatus executes a process associated with the keyword. Finally, image formation apparatus 600 to be instructed transmits to image formation apparatus 100B a response indicating whether the instruction has successfully been recognized.

Thus, in one or more embodiments, a part of step S5 performed in image formation apparatus 100 according to the aforementioned embodiments or image formation apparatus 100A according to the aforementioned embodiments is performed in image formation apparatus 600 to be instructed. Other than that, image formation apparatus 100B according to one or more embodiments has the same hardware configuration as image formation apparatus 100 according to the aforementioned embodiments or image formation apparatus 100A according to the aforementioned embodiments (FIG. 2), and executes a similar process (steps S1 to S6).

In one or more embodiments the number of image formation apparatuses connected to image formation apparatus 100B via network 99 is not limited to a single image formation apparatus and a plurality of image formation apparatuses may be connected.

Further, in one or more embodiments, image formation apparatus 600 to be instructed converts a keyword, and accordingly, it is desirable that a variety of types of tables (e.g., tables TB1, TB2, TB3, TB4 etc.) be stored in a server or the like connected to image formation apparatus 600 via network 99 so that image formation apparatus 600 connected to image formation apparatus 100B via network 99 can refer to the tables.

In one or more embodiments, in addition to the effect of the aforementioned embodiments, a part of the process executed by image formation apparatus 100 according to the aforementioned embodiments or image formation apparatus 100A according to the aforementioned embodiments can be performed by image formation apparatus 600 to be instructed, and a burden on image formation apparatus 100B for a process can effectively be alleviated.

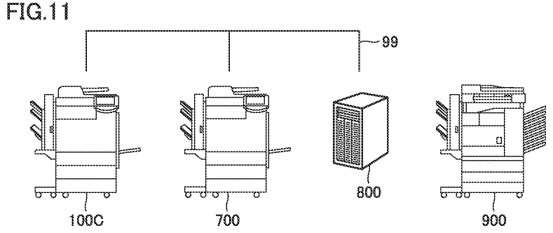

FIG. 11 is a schematic diagram for illustrating a network configuration according to one or more embodiments. An image formation apparatus 100C, an image formation apparatus 700, and a server 800 are connected via network 99, and all have a voice recognition function and can recognize voice. Image formation apparatuses 100C and 700 can receive an instruction via voice and can execute a process based on the instruction. Further, image formation apparatus 100C can receive via voice an instruction intended for image formation apparatus 700. Image formation apparatus 100C is not connected to image formation apparatus 900 via network 99 and cannot receive via voice an instruction intended for image formation apparatus 900.

In one or more embodiments, a part of step S5 performed in image formation apparatus 100 according to the aforementioned embodiments or image formation apparatus 100A according to the aforementioned embodiments is performed in server 800. Specifically, in the aforementioned embodiments, when image formation apparatus 100 or 100A receives via voice an instruction intended for an image formation apparatus connected via network 99 (e.g., image formation apparatuses 200, 300, 400, 500), image formation apparatus 100 or 100A converts the instruction and transmits the converted instruction to the image formation apparatus to be instructed.

In one or more embodiments, in contrast, when image formation apparatus 100C receives via voice an instruction intended for image formation apparatus 700 connected to image formation apparatus 100C via network 99, image formation apparatus 100C does not convert the received instruction and transmits the instruction to server 800 in the form of voice data. When server 800 receives the instruction transmitted from image formation apparatus 100C, server 800 converts the instruction and transmits the converted instruction in the form of voice data to image formation apparatus 700 to be instructed. Specifically, initially, server 800 identifies information of image formation apparatus 100C (the manufacturer of image formation apparatus 100C, a language that image formation apparatus 100C can recognize, etc.) and information of image formation apparatus 700 to be instructed (the manufacturer of image formation apparatus 700, a language that image formation apparatus 700 can recognize, etc.), and adds lacked information to the instruction. Subsequently, server 800 converts a keyword included in the instruction to a keyword that image formation apparatus 700 to be instructed can recognize, and transmits the converted keyword to image formation apparatus 700 to be instructed. Image formation apparatus 700 to be instructed receives the instruction transmitted from server 800 and executes a process associated with the keyword included in the instruction. Furthermore, image formation apparatus 700 to be instructed transmits to image formation apparatus 100C a response indicating whether the instruction has successfully been recognized.

Thus, in one or more embodiments, a part of step S5 performed in image formation apparatus 100 according to the aforementioned embodiments or image formation apparatus 100A according to the aforementioned embodiments is performed in server 800. Other than that, image formation apparatus 100C according to one or more embodiments has the same hardware configuration as image formation apparatus 100 according to the aforementioned embodiments or image formation apparatus 100A according to the aforementioned embodiments (FIG. 2), and executes a similar process (steps S1 to S6).

In one or more embodiments the number of image formation apparatuses connected to image formation apparatus 100C via network 99 is not limited to a single image formation apparatus and a plurality of image formation apparatuses may be connected.

Further, in one or more embodiments, server 800 converts a keyword, and accordingly, it is desirable that a variety of types of tables (e.g., tables TB1, TB2, TB3, TB4, etc.) be stored in server 800.

In one or more embodiments, in addition to the effect of the aforementioned embodiments, a part of the process executed by image formation apparatus 100 according to the aforementioned embodiments or image formation apparatus 100A according to the aforementioned embodiments can be performed by server 800, and a burden on image formation apparatus 100C for a process can effectively be alleviated.

Note that the aforementioned embodiments may be combined as desired.

Furthermore, according to one or more embodiments, there is provided a method for controlling an image formation apparatus connectable to another image formation apparatus via a network. The method comprises: receiving an instruction via voice; determining whether the received instruction is intended for the other image formation apparatus; converting the received instruction to an instruction associated with the other image formation apparatus when it is determined that the received instruction is intended for the other image formation apparatus; and transmitting the converted instruction to the other image formation apparatus.

The method comprises identifying a manufacturer of the other image formation apparatus. Converting the received instruction to an instruction associated with the other image formation apparatus includes converting the received instruction to an instruction associated with the identified manufacturer.

The method comprises identifying a language that the other image formation apparatus can recognize. Converting the received instruction to an instruction associated with the other image formation apparatus includes converting the received instruction to an instruction using the identified language.

A process associated with an instruction includes a plurality of types of options including a process executed with a first setting and a process executed with a second setting. The method comprises adding setting information to the received instruction when the received instruction does not designate any one of the first setting and the second setting. Transmitting the converted instruction to the other image formation apparatus includes transmitting the converted instruction together with the added setting information.

The image formation apparatus is connectable to a plurality of other image formation apparatuses via a network. The method comprises associating an instruction associated with each of the plurality of other image formation apparatuses with an instruction receivable by the image formation apparatus, and storing them. Determining whether the received instruction is intended for the other image formation apparatus includes determining which of the plurality of other image formation apparatuses the received instruction is intended for. Converting the received instruction to an instruction associated with the other image formation apparatus includes, when an instruction associated with a specific image formation apparatus of the plurality of other image formation apparatuses that follows the determining is not stored, converting the received instruction to an instruction stored in association with the received instruction and associated with another image formation apparatus other than the specific image formation apparatus. Associating an instruction associated with each of the plurality of other image formation apparatuses with an instruction receivable by the image formation apparatus and storing them includes, when the converted instruction is transmitted to the specific image formation apparatus and thereafter notification allowing recognition of the instruction to be determined is received from that specific image formation apparatus, storing the instruction associated with the other image formation apparatus other than the specific image formation apparatus as an instruction associated with that specific image formation apparatus.

The image formation apparatus is connectable to a plurality of other image formation apparatuses via a network. The method comprises associating an instruction associated with each of the plurality of other image formation apparatuses with an instruction receivable by the image formation apparatus, and storing them. Determining whether the received instruction is intended for the other image formation apparatus includes determining which of the plurality of other image formation apparatuses the received instruction is intended for. Converting the received instruction to an instruction associated with the other image formation apparatus includes, when an instruction associated with a specific image formation apparatus of the plurality of other image formation apparatuses that follows the determining is not stored, converting the received instruction to an instruction stored in association with the received instruction and associated with each of the plurality of other image formation apparatuses other than the specific image formation apparatus. Transmitting the converted instruction to the other image formation apparatus includes transmitting the instruction associated with each of the plurality of other image formation apparatuses other than the specific image formation apparatus to the specific image formation apparatus collectively.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image formation apparatus comprising:
a network interface connectable to another image formation apparatus via a network; and
a controller that controls the image formation apparatus, wherein
the controller:
receives an instruction via voice;
determines whether the received instruction is intended for the other image formation apparatus;
upon determining that the received instruction is intended for the other image formation apparatus, converts the received instruction into an instruction associated with the other image formation apparatus; and
transmits the converted instruction to the other image formation apparatus.

2. The image formation apparatus according to claim 1, wherein
the controller further:
identifies a manufacturer of the other image formation apparatus, and
converts the received instruction into an instruction associated with the identified manufacturer.

3. The image formation apparatus according to claim 1, wherein
the controller further:
identifies a language that the other image formation apparatus can recognize, and
converts the received instruction into an instruction using the identified language.

4. The image formation apparatus according to claim 1, wherein
a process associated with the instruction includes a plurality of types of options including a process executed with a first setting and a process executed with a second setting, and
the controller further:
adds setting information to the received instruction when the received instruction does not designate any one of the first setting and the second setting, and
transmits the converted instruction together with the added setting information.

5. The image formation apparatus according to claim 1, wherein
the network interface is connectable to a plurality of other image formation apparatuses via a network, and
the controller further:
associates an instruction associated with each of the other image formation apparatuses with an instruction receivable by the image formation apparatus and stores the associated instruction,
determines which of the other image formation apparatuses the received instruction is intended for,
when an instruction associated with a specific image formation apparatus determined from among the other image formation apparatuses is not stored, converts the received instruction into an instruction stored in association with the received instruction and associated with another image formation apparatus other than the specific image formation apparatus, and
when the converted instruction is transmitted to the specific image formation apparatus and thereafter notification allowing recognition of the instruction to be determined is received from that specific image formation apparatus, stores the instruction associated with the other image formation apparatus as an instruction associated with the specific image formation apparatus.

6. The image formation apparatus according to claim 1, wherein
the network interface is connectable to a plurality of other image formation apparatuses via a network, and
the controller further:
associates an instruction associated with each of the other image formation apparatuses with an instruction receivable by the image formation apparatus and stores the associated instruction,
determines which of the other image formation apparatuses the received instruction is intended for,
when an instruction associated with a specific image formation apparatus determined from among the other image formation apparatuses is not stored, converts the received instruction into an instruction stored in association with the received instruction and associated with each of the other image formation apparatuses other than the specific image formation apparatus, and
transmits the instruction associated with each of the other image formation apparatuses other than the specific image formation apparatus to the specific image formation apparatus collectively.

7. A non-transitory computer readable recording medium storing a program for controlling an image formation apparatus connectable to another image formation apparatus via a network, the program causing a computer to:
receive an instruction via voice;
determine whether the received instruction is intended for the other image formation apparatus;
convert the received instruction into an instruction associated with the other image formation apparatus when the computer determines that the received instruction is intended for the other image formation apparatus; and
transmit the converted instruction to the other image formation apparatus.

8. The computer readable recording medium according to claim 7, wherein
the program further causes the computer to:
identify a manufacturer of the other image formation apparatus, and
converts the received instruction into an instruction associated with the identified manufacturer.

9. An image formation system comprising:
a first image formation apparatus that comprises a first controller; and
a second image formation apparatus that comprises a second controller and is connected to the first image formation apparatus via a network, wherein
the first controller:
receives an instruction via voice;
determines whether the received instruction is intended for the second image formation apparatus;
upon determining that the received instruction is for the second image formation apparatus, converts the received instruction into an instruction associated with the second image formation apparatus; and
transmits the converted instruction to the second image formation apparatus, and
the second controller:
receives the instruction transmitted by the first image formation apparatus; and
executes a process based on the received instruction.

10. The image formation system according to claim 9, wherein
the first controller further:
identifies a manufacturer of the second image formation apparatus, and
converts the received instruction into an instruction associated with the identified manufacturer.

11. The image formation system according to claim 9, wherein
the first controller further:
identifies a language that the second image formation apparatus can recognize, and
converts the received instruction into an instruction using the identified language.

12. The image formation system according to claim 9, wherein
a process associated with the instruction includes a plurality of types of options including a process executed with a first setting and a process executed with a second setting,
the first controller further:
adds setting information to the received instruction when the received instruction does not designate any one of the first setting and the second setting, and
transmits the converted instruction together with the added setting information.

13. An image formation system comprising:
a first image formation apparatus that comprises a first controller; and
a second image formation apparatus that comprises a second controller and is connected to the first image formation apparatus via a network, wherein
the first controller:
receives an instruction via voice,
determines whether the received instruction is intended for the second image formation apparatus, and
upon determining that the received instruction is for the second image formation apparatus, transmits the received instruction to the second image formation apparatus,
the second controller:
receives the instruction transmitted by the first image formation apparatus,
converts the received instruction into an instruction associated with the second image formation apparatus, and
executes a process based on the converted instruction.

14. The image formation system according to claim 13, wherein
the second controller further:
identifies a manufacturer of the first image formation apparatus, and
converts the received instruction from an instruction associated with the identified manufacturer into an instruction associated with a manufacturer of the second image formation apparatus.

15. The image formation system according to claim 13, wherein
the second controller further:
identifies a language that the first image formation apparatus can recognize, and
converts the received instruction from an instruction using the identified language into an instruction using a language that the second image formation apparatus can recognize.

16. The image formation system according to claim 13, wherein
a process associated with the instruction includes a plurality of types of options including a process executed with a first setting and a process executed with a second setting, and
the second controller adds setting information to the converted instruction when the received instruction does not designate any one of the first setting and the second setting.

17. An image formation system comprising:
a first image formation apparatus that comprises a first controller;
a second image formation apparatus that comprises a second controller; and
a server that comprises a third controller and is connected to the first image formation apparatus and the second image formation apparatus via a network, wherein
the first controller:
receives an instruction via voice,
determines whether the received instruction is intended for the second image formation apparatus, and
upon determining that the received instruction is intended for the second image formation apparatus, transmits the received instruction to the server,
the third controller:
converts the instruction transmitted by the first image formation apparatus into an instruction associated with the second image formation apparatus, and
transmits the converted instruction to the second image formation apparatus,
the second controller:
receives the instruction transmitted by the server, and
executes a process based on the received instruction.

18. The image formation system according to claim 17, wherein
the third controller further:
identifies a manufacturer of the second image formation apparatus, and
converts the received instruction into an instruction associated with the identified manufacturer.

19. The image formation system according to claim 17, wherein
the third controller further:
identifies a language that the second image formation apparatus can recognize, and
converts the received instruction into an instruction using the identified language.

20. The image formation system according to claim 17, wherein
a process associated with the instruction includes a plurality of types of options including a process executed with a first setting and a process executed with a second setting, and
the third controller further:
adds setting information to the received instruction when the received instruction does not designate any one of the first setting and the second setting, and
transmits the converted instruction together with the added setting information.
